(19) United States
(12) Patent Application Publication
(10) Pub. No.: US 2004/0135739 A1
(43) Pub. Date: Jul. 15, 2004

(54) Three-dimensional image display method, device for the same, light direction detector, and light direction detecting method

(75) Inventors: Rieko Fukushima, Tokyo (JP); Kazuki Taira, Tokyo (JP); Yuzo Hirayama, Kanagawa (JP)

Correspondence Address: Finnegan, Henderson, Farabow,, Garrett & Dunner, L.L.P., 1300 I Street, N.W., Washington, DC, 20005-3315, US

(73) Assignee: Kabushiki Kaisha Toshiba

(21) Appl. No.: 10/612,009

(22) Filed: Jul. 3, 2003

(30) Foreign Application Priority Data
Jul. 5, 2002 (JP) P. 2002-196859
Jul. 1, 2003 (JP) P. 2003-189226

(51) Int. Cl. G09G 5/00

(52) U.S. Cl. 345/6

(57) ABSTRACT

A plurality of light direction detectors are provided on an image display screen and the position of a light source in the real space is detected so as to give a shadow to a display object within a display image by seasoning three-dimensional image data with these items of information.

This application is based upon and claims the benefit of priority from the prior Japanese Patent Application No.2002-196859 filed on Jul. 5, 2002 and Japanese Patent Application No.2003-189226 filed on Jul. 1, 2003; the entire contents of which are incorporated herein by reference.

### BACKGROUND OF THE INVENTION

1. Field of the Invention

The present invention relates to a three-dimensional image display device.

2. Description of the Related Art

Although there are several ideas for dividing three-dimensional image display methods, the three-dimensional image display methods are divided into two systems broadly.

One of the systems is to employ a binocular parallax and the other is to actually form a space image.

As the binocular parallax, there have been proposed various systems with or without the presence of spectacles, starting with a binocular system having picture information in the left and right eyes up to a multi-ocular system for making obtainable images close to more real-three-dimensional pictures by forming a plurality of observant positions at the time of taking pictures so as to increase an amount of information. With respect to the multi-ocular system, what uses lenticular or parallax lenses generally without using spectaculars is well known though there are systems using spectacles as well.

A space image reconstruction system is an ideal three-dimensional image reconstruction system and holography falls under this category. Moreover, an integral photographic system proposed by Lippmann of France in 1908 should also be classified into the category of the space image reconstruction system because a perfect three-dimensional image is reconstructed as a ray of light follows one path during the time of taking a photograph and the reverse path during that of reconstruction.

As described above, though there have been proposed various methods and devices for displaying three-dimensional images, an ultimate three-dimensional image display is such that the image displayed looks natural as though it actually exists in real space.

Heretofore, attempts have been made to examine the unification of directions of illumination when two-dimensional images are synthesized on the basis of a plurality of image sources (JP-A-7-46577 and JP-A-2001-60082). Further, other attempts have been made to examine setting conditions of a light source in the real space to coincide with conditions of a light source of image information and enhancing realistic sensations (JP-A-7-46577).

In addition, a portable display having an optical detector has already been proposed (JP-A-6-70267). This display is designed to detect direction of light source and lightness in a system in which user observes a three-dimensional electronic image and the real space simultaneously to add shade corresponding to an electronic image. This optical detector is installed to acquire the direction of illumination. However, acquiring only the direction of illumination is not enough to deal with a case where the angle and lightness of illumination vary with the position of the three-dimensional image displayed.

In JP-A-6-70267, there have also been proposed structures as light source direction detecting structures in which a bar is perpendicularly uprighted on a photoelectric conversion substrate with optical detectors represented by CCDs and arranged horizontally and two-dimensionally, and otherwise pin-holes are provided. However, when the angle between the direction of a light source and a photoelectric conversion substrate is small, that is, when a position of the light source is low, an end portion of a shadow of the bar projects to outside of the photoelectric conversion substrate. Therefore, a detectible light source direction is limited.

With the three-dimensional image display in which importance is specifically attached to harmony with the real space from the nature of the image display, only a little attention has been directed to the relation of illumination between the three-dimensional image and the real space despite the fact that it is extremely important to make an observer recognize the three-dimensional image as a natural image (Mixed Reality).

In other words, natural image display has been unsatisfactory in the image display method using the conventional three-dimensional image together with the optical detectors.

Moreover, the detection range in the conventional optical detectors has been restricted.

### BRIEF SUMMARY OF THE INVENTION

According to embodiments of the invention, a three-dimensional image display method includes detecting a position of a light source, comparing the position of the light source and a virtual position of a display object in a three-dimensional image to obtain a relative positional relation therebetween, and shading the three-dimensional image.

According to embodiments of the invention, a three-dimensional image display device includes detection means for detecting a position of a light source, and an image process unit configured to compare the position of the light source and a virtual position of a display object in a three-dimensional image to obtain a relative positional relation therebetween, and shades the three-dimensional image.

According to embodiments of the invention, a light source direction detection device includes a light source detection array disposed on a substrate; and a discontinuous light shielding member standing perpendicularly to the substrate.

### BRIEF DESCRIPTION OF THE DRAWINGS

FIG. 1 is a diagram showing a schematic flow of the detection of the position of a light source and three-dimensional image display data.

FIG. 2 shows an example in which two light direction detectors according to an embodiment 1 are provided.

FIG. 3 is a diagram illustrating the constitution of the light direction detectors according to the embodiment 1.

FIG. 4 is a diagram illustrating an operation of the light direction detectors according to the embodiment 1.

FIG. 5 shows an example of a display according to the embodiment 1.

FIG. 6 is a diagram illustrating the constitution of the light direction detectors according to an embodiment 2.

FIG. 7 shows another example of a light direction detector according to the embodiment 2.

FIG. 8 is a diagram illustrating an operation of the light direction detector according to the embodiment 2.

FIG. 9 shows still another example of a light direction detector according to the embodiment 2.

FIG. 10 is a diagram illustrating the detection of the positions of light sources according to an embodiment 3.

FIG. 11 is a diagram illustrating a method for detecting the positions of the light sources according to the embodiment 3.

FIG. 12 is shows an example of a display according to the embodiment 3.

FIG. 13 shows an example of an image display unit.

FIG. 14 shows further another example of a light direction detector according to the embodiment 2.

FIG. 15 shows an example of a color CCD having a YMC stripe arrangement.

### DETAILED DESCRIPTION OF THE INVENTION

Embodiments of the invention will now be described in detail by reference to the drawings.

(Embodiment 1)

In a three-dimensional image display with a display image spatially spreading out, it is important to reflect in a three-dimensional image the condition of a display object at a display position within the three-dimensional image in order to display a natural image in harmony with its illumination environment. Therefore, the direction and luminosity in an imaginary position where the display object exists have to be detected. In other words, the position of a light source itself with respect to an image display device is detected whereby to capture information about the position of the light source into the three-dimensional image.

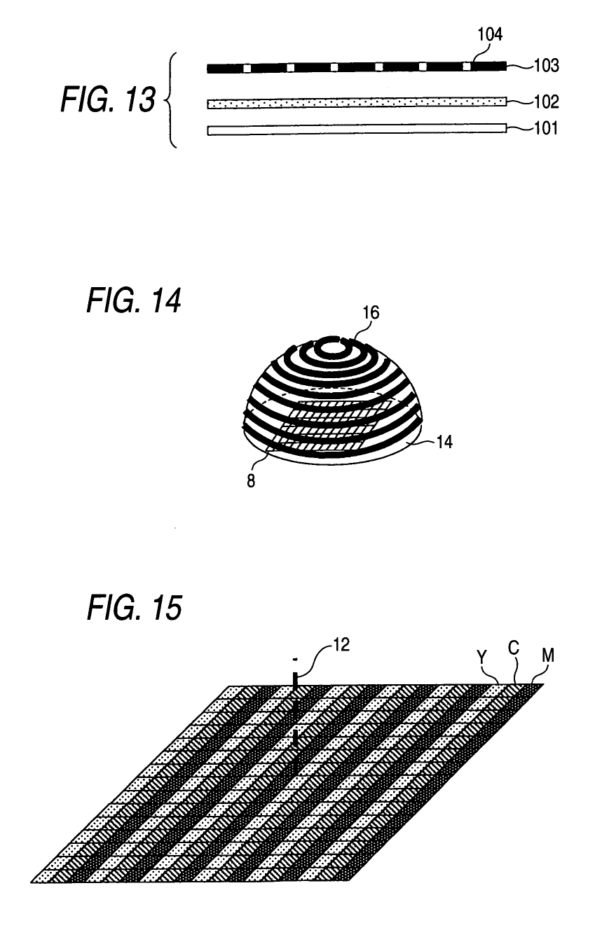

The invention employs the integral photography method as a method for displaying a three-dimensional image in the space. A three-dimensional image display device to which the integral photography method is applied can reproduce a natural three-dimensional image by a simple light ray direction control system. The light ray direction control system includes an image display unit such as a liquid crystal display having a display element array in which image display elements corresponding to pixels are arranged in row and column manners, and an opening control section 103 of pin-holes or micro lenses arranged two-dimensionally. In FIG. 13, a light source 101, an image display unit 102, and the opening control section 103 are arranged in this order. Reference numeral 104 denotes openings or translucent members. However, the light source 101, the opening control section 103, and the image display unit 102 may be arranged in this order.

On this three-dimensional image display device, a plurality of image patterns corresponding to element images, which are slightly different from each other in vision depending on a viewing angle, are displayed with corresponding to the pin-holes or the micro lenses, respectively. Alight ray emitted from the plurality of image patterns corresponding to the element images and passing through the corresponding pin-holes or the micro-lenses or a light ray emitted from the light source, passing through the pin-holes or the micro lenses, and going through the image patterns is emitted ahead of the three-dimensional image display device to form a three-dimensional actual image. Also, when loci of these light rays are extrapolated into a back surface of the opening control section 103 of the pin-holes or the micro lenses, a three-dimensional virtual image (an image not being present when viewed from the back surface side) is observed on the back surface of the opening control section 103 of the pin-holes or the micro lenses. In other words, an observer observes the element-image light-ray groups forming an image on the front surface of the opening control section 103 as the three-dimensional actual image, and the element-image light-ray groups of which loci form an image on the back surface of the opening control section 103, as the three-dimensional virtual image.

As described above, there have been proposed various methods for displaying a three-dimensional image in the real space. However, an ultimate three-dimensional image display is such that the image displayed looks natural as though it actually exists in real space. From this view point, since the integral photography method can form a natural stereoimage with a simple construction, the integral photography method is considered as a superior one. Also, since the integral photography method reproduces a stereoimage actually, there is no need to use an optical device such as polarized glasses. Natural motion parallax is obtained, because a viewed angle of the stereoimage is changed depending on a viewing angle of an observer. Therefore, the integral photography method is also superior one in terms of reproducing the stereoimage more real.

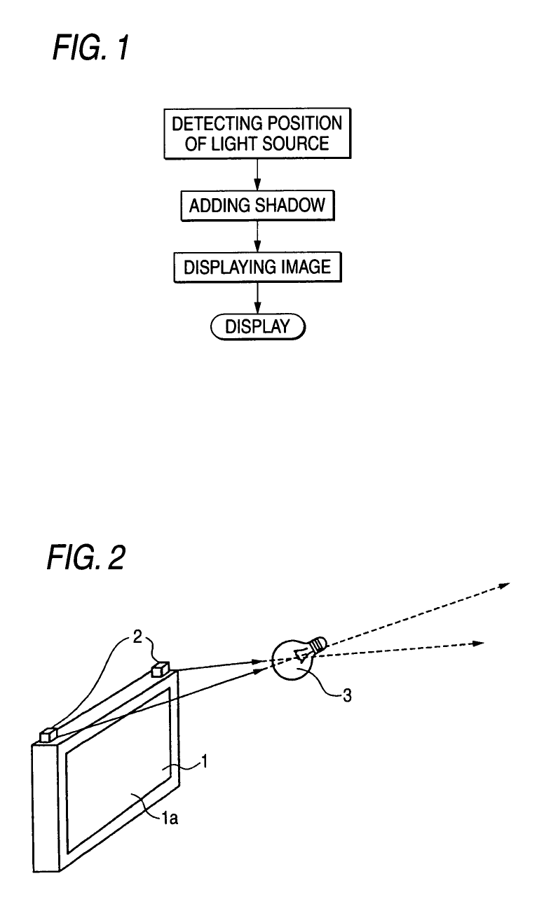

As one embodiment of this three-dimensional image display device, the relative position of a light source 3 with respect to an image display device is detected as shown in FIG. 1. Then the detected position of the light source 3 is compared with an imaginary position of a display object within the image in three-dimensional image data so as to obtain a shadow to be attached to the display object. Then, the three-dimensional image data is processed and displayed. It also becomes possible to process the shade with the intensity of the illumination taken into consideration.

As shown in FIG. 2, two light direction detectors 2 are provided in the upper portion of the image display device 1 for detecting the position of the light source 3 and determining the lightness of the light source 3.

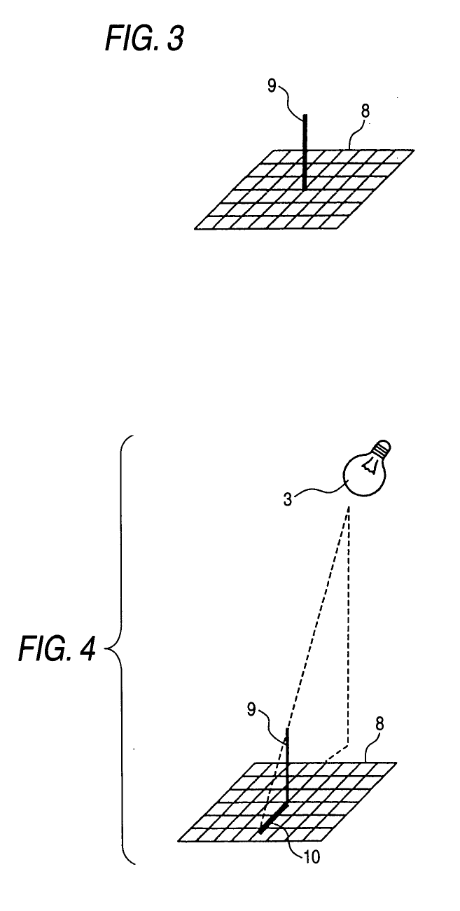

As shown in FIG. 3, one including an upright shielding bar 9 in the center of a substrate 8 on which photoelectric conversion elements are arranged in array may be used as the light direction detector 2. When light is incident on the light direction detector 2, a shadow 10 of the shielding bar 9 appears on the substrate 8 as shown in FIG. 4. By detecting the shadow with an array of photoelectric conversion elements, the direction and angle of incidence can be obtained.

When the light direction is detected at two points using these light direction detectors 2, the light source 3 is located at the intersection between the detected two directions. Therefore, the position of the light source 3 with respect to the three-dimensional image display device 1 can be obtained accurately. If the light direction detector 2 is also made to detect the intensity of incident light, approximate lightness of the light source 3 can be obtained from contrast between the shade portions and the other portions.

Although two of the light direction detectors 2 are employed by way of example in this case as described above, more light direction detectors may be provided. Installation of more than two light direction detectors allows the individual light direction detectors to complement each other in view of measuring precision. However, installation of many light direction detectors results in specifying the positron of each light source more precisely in a wider range on one hand, but the calculation of the positions of the light direction detectors for identifying purposes tends to become complicated on the other. As an increase in costs due to an increase in the number of parts is also anticipated, it is not necessarily desirable to increase the number of light direction detectors but preferable to select a proper number of them depending on application.

The light direction detectors 2 may be moved in response to the movement of the display screen 1a of the image display device 1. That is, the light direction detectors 2 are arranged at positions where the light direction detectors 2 can detect light from a light source positioned in the same direction as a display direction of the display screen 1a, or the light direction detectors 2 are arranged at positions where the light direction detectors 2 can detect light from the light source incident in the same direction as a direction from which the three dimensional image is observed. This is intended to detect the change of the relative position between the display screen 1a and the light source 3 when the direction of the display screen 1a is changed. Providing the light direction detectors 2 integrally with the display screen 1a in particular is convenient as the relative positional relation between the direction of the display screen 1a and the light source 3 is properly detected. Generally, there are many cases where the light source 3 is in a position higher than that of the display screen 1a, so that it is practical to mount the light direction detectors 2 higher in position than the display screen 1a. In this case, the light direction detectors 2 may be provided as parts contiguous to the display screen 1a of the three-dimensional image display device 1 or as those embedded in or secured to the peripheral edge of the display screen 1a. In case that the light direction detectors 2 are installed separately from the display screen 1a, an additional device for recognizing the direction of the image display screen 1a will be needed because the relative positional relation between the light source 3 and the display screen 1a changes when the direction of the image display screen 1a is changed.

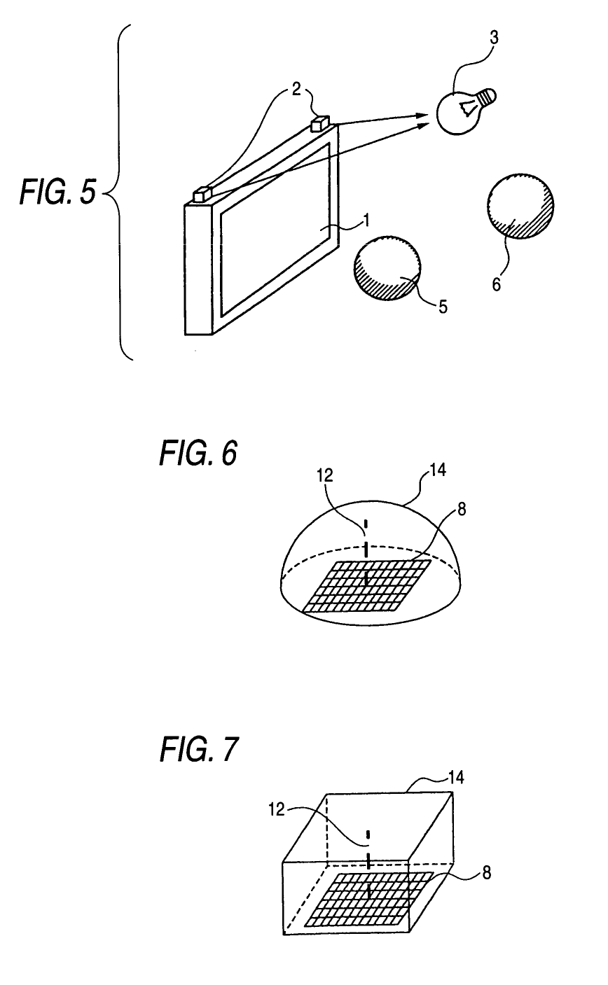

Next, shadows are added to display objects 5 and 6 on comparison between the position and lightness of the light source 3 thus obtained and the imaginary positions of the display objects within the three-dimensional image displayed (see FIG. 5) More specifically, a shadow is added to the side of the display device 1 in case where the position of the display object 5 is closer than the light source 3 with the display device 1 being as a reference and a shadow is added to the opposite side of the display device 1 in case where the position of the display object 6 is farther than the light source 3. It is needless to say that, such a shadow is properly added to the side, opposite side, the right or the left of the display device 1, depending on the position of the light source 3. Moreover, the shade of the shadow can be made adjustable by changing the luminous intensity of the light source 3. When displayed content is a 3D-CG, a technique, in an existing rendering software, for adding shade to the content with the light source being located at a desirable position has been known. It is possible to generate a CG image on which the lighting condition in the real space is reflected, by using such a rendering software and reproducing a virtual light source in a CG space in which conditions such as the detected position and lightness of the actual light source are given. When the displayed content is an actually photographed image, the content can be dealt in a similar way so long as the actually photographed image data has been converted into a 3D modeling data, for example, by a method which converts the photographed image data into a surface model such as polygon and mapping an image onto a shape data. Also, when an original 3D data has already been given some kind of light source condition in the CG space, the light source condition in the CG space and the obtained light source condition in the real space are mixed. With regard to a phenomenon in which application of the light source in the real space onto the display screen decreases the contrast, there have been proposed many techniques for modulating display luminance or the like to compensate the decrease of the contrast, in not only the three-dimensional display device but also other fields. The techniques include ###, ###, and ###, which may be incorporated herein by reference in its entirety.

Thus, the light source conditions in the real space can be matched to the position of the three-dimensional image to be displayed using the obtained position of the light source to process the three-dimensional image to be displayed, so that a more natural three-dimensional image becomes displayable.

(Embodiment 2)

According to this embodiment, a light direction detector is made adaptable to a broad range of light incidence directions and capable of detecting the direction and angle of incidence with a high degree of accuracy.

FIG. 6 shows a light direction detector according to this embodiment.

A shielding body 12 is provided in the central portion of a substrate 8 on which photoelectric conversion elements arranged in array within a semispherical transparent resin 14, the shielding body 12 being disposed to be perpendicular to the substrate 8. The shielding body 12 is partly transparent 15, and discontinuous against light.

The photoelectric conversion element array may be formed of CCDs approximately 10 mm square in each of which photoelectric elements approximately 5 μm square are set in planar array.

The shielding body 12 within the transparent resin 14 has approximately 2.5 mm high and includes a transparent part having approximately 50 μm in pitch. In this case, a bar-like body made of combining a shielding material and a transparent material alternately together is prepared to form the shielding body 12, which may be fixedly installed within the transparent resin 14, or otherwise bar-like shielding bodies are provided and fixedly set at intervals therein.

Although a description has been given of a case that the semispherical transparent resin 14 is used, a cubic transparent resin 14 may also be employed as shown in FIG. 7. However, the semispherical one is preferred in that it can deal with any situation omnidirectionally.

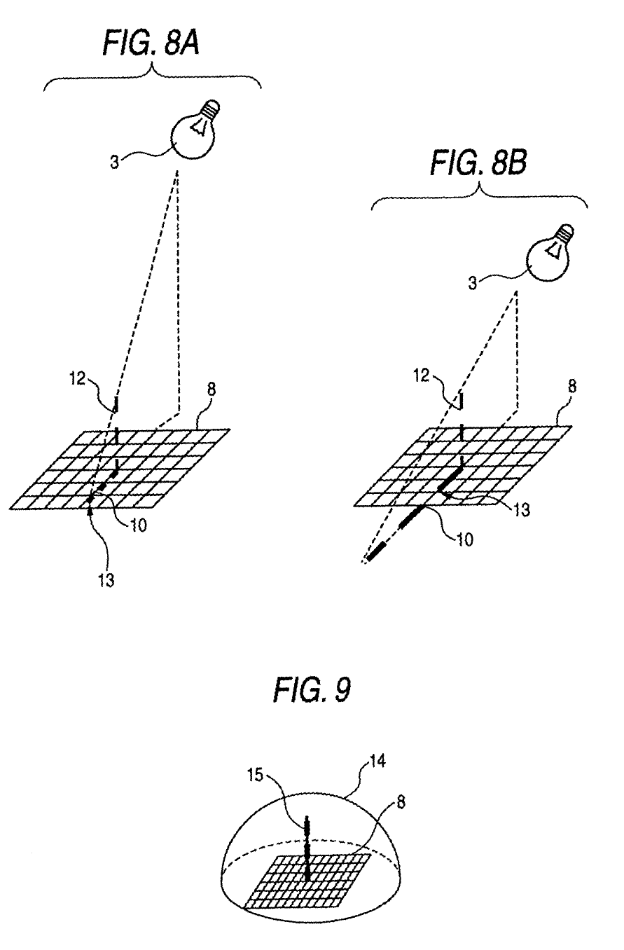

The operation of the light direction detector thus arranged will be described by reference to FIG. 8.

When the position of a light source 3 is high with respect to the light direction detector, as shown in FIG. 8(a), the photoelectric conversion element array detects a position of the front end of the shadow 10 of the shielding body 12 to obtain the direction and angle of incidence. In this case, the front end of the shadow 10 of the shielding body 12 can be obtained from the number of shadows 10 of the shielding body 12. In this example shown, the end of the third shadow from the root of the shielding body 12 represents the front end of the shadow of the shielding body 12.

When the position of the light source 3 is low with respect to the light direction detector, on the other hand, the incidence direction can be obtained similarly from the direction of the shadow 10 as shown in FIG. 8(b). Further, the shielding body 12 is so structured as in the form of a broken line in order to obtain the angle of incidence by detecting the number of shadows 10 from the root of the shielding body 12 as well as the position of the front end of each shadow.

Thus, the light direction detectors according to this embodiment can detect the entire direction of the light source omnidirectionally.

Although the broken-line-like shielding body 12 has been described so far, the same effect is achievable as long as the form of the shielding body has periodicity though it is not completely discontinuous. As shown in FIG. 9, for example, there may be used a shielding body 15 whose thickness varies periodically. Also, as shown in FIG. 14, a shielding member 16 may be configured so that transparent regions and shielding regions are formed concentrically alternatively on the semispherical transparent resin 14. The shielding member 16 operates in a similar manner to the shielding member 12 shown in FIG. 6.

Although an example corresponding to an omnidirectional light source with the shielding body positioned in the central portion of the photoelectric conversion element array has been described, it would be useful to shift the position of the shielding body from the center because the light source is often positioned in front of the image display device. In other words, as the shadows of the shielding body extend toward the rear of the display screen when the light source is positioned in front of the image display device, the photoelectric conversion element array becomes effectively utilizable by setting the position of the shielding body on the front side of the photoelectric conversion element array. Practical light direction detectors can be made by limiting the light detecting direction to a certain extent.

Further, the photoelectric conversion element array makes it possible to detect the shade of the shadow as with the embodiment 1. Therefore, the intensity of the incident light can be obtained.

(Embodiment 3)

This embodiment is intended to deal with a case where there exist a plurality of light sources.

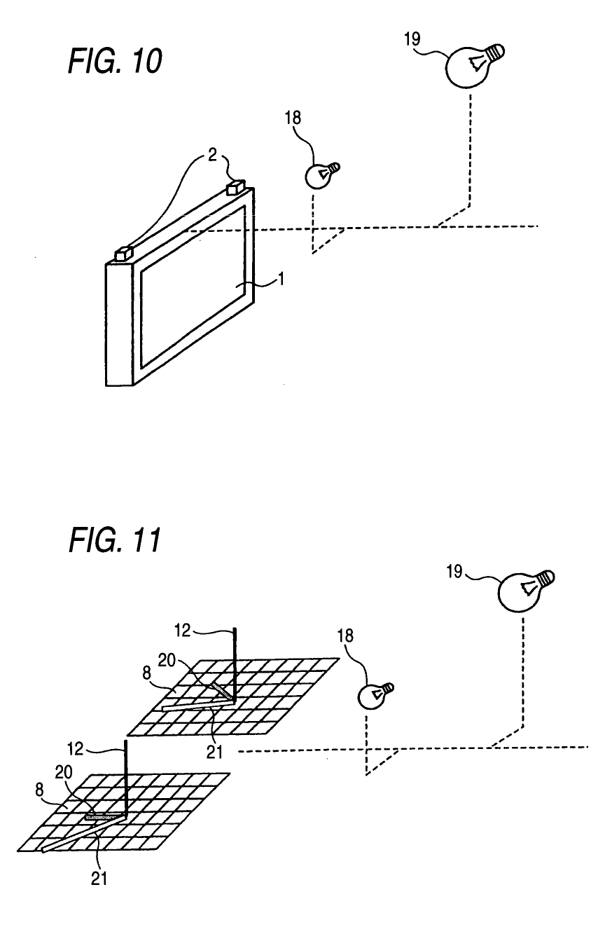

A description will now be given of a case where two light direction detectors 2 are as shown in FIG. 10 provided on a three-dimensional image display device 1 and light sources 18 and 19 are present, by way of example.

FIG. 11 is an exemplary diagram illustrating a state of shadows formed in the respective light direction detectors 2. In this case, the light direction detectors 2 having shielding bodies 12 will be described, as with the embodiment 1 for the sake of simplifying the explanation; however, the broken-line-like shielding bodies as described in the embodiment 2 may be applied thereto.

Where there are a plurality of light sources 18 and 19, shadows 20 and 21 corresponding to the number of light sources appear in each light direction detector 2. The shade of the shadows 20 and 21 differs depending on the distance to and the lightness of the derived light sources 18 and 19.

Incidentally, the photoelectric conversion element arrays 8 can detect the depth of the shadows by properly selecting the sensitivity of them.

Therefore, the shadow derived from the light source 18 is distinguishable from that derived from the light source 19 by the direction and depth of the shadow out of the shadows 20 and 21 within the respective light direction detectors 2 when the distance between the light direction detectors 2 is shorter than the distance up to the light sources 18 and 19. Then, a plurality of positions of light sources 18 and 19 are detected by combining the shadows within the respective light direction detectors 2.

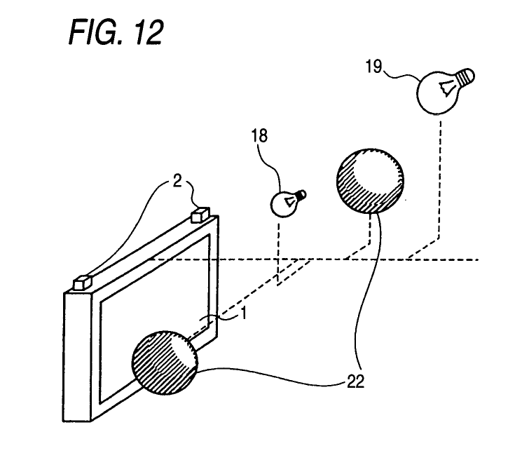

Thus, it is possible to display the three-dimensional image data with each of light source conditions taken into consideration, using information on the detected positions of the light sources (see FIG. 12). In other words, contrast derived from each of light sources 18 and 19 is given to a display object based on the positions of the light sources 18 and 19 and directions from the display object in the three-dimensional image data to the light sources 18 and 19. In addition, the luminance of the three-dimensional image data is adjusted based on an average luminance.

Further, the average luminance of the whole peripheral illumination environment including indirect light is obtained from the average output of the photoelectric conversion element array 8 other than the shadows, the average luminance thus obtained is added to three-dimensional image display data and, and the lightness of the display object is adjusted, so that a natural display image can be obtained.

Accordingly, a more natural three-dimensional image can be obtained by re-forming and displaying the three-dimensional image in which the light source condition in the real space is taken into consideration.

In the above description, the example has been described in which information on each shadows 20 and 21 corresponding to the plurality of light sources 18 and 19 is incorporated into the three-dimensional image data. However, for the sake of simplification, the shadows 20 and 21 may not be separated for the detection.

In other words, it is also possible that a single light source resulting from synthesizing light from the plurality of light source s is imagined in advance based on information on the plurality of shadows and a position of the single light source is added to the three-dimensional image data.

An easier method for properly selecting the sensitivity of the photoelectric conversion element array 8 whereby to reflect information on the principal light source is also possible according to the end of display.

(Embodiment 4)

This embodiment is intended to take colors of light sources into consideration by making the photoelectric conversion element array of a light direction detector distinguish the three primary colors.

The photoelectric conversion element array of the light direction detector is covered with three color filters so as to detect each of the three primary colors. A so-called color CCD element is applied to the light direction detector (single substrate system). There is a 3CCD system in which three CCDs having the same resolution are combined with prism spectroscopy. Although the 3CCD system can realize high precision, a device itself becomes large. Therefore, the 3CCD system is not suitable for this invention. A three-primary-colors filter of the single substrate system according to the embodiment may use the RGB arrangement (primary-colors CCD) or the YMC arrangement (complementary-colors CCD). The former has an advantage that the precision for detecting color is high. The latter has an advantage that the sensitivity is high (detection can be made in a dark room). Here, the YMC stripe arrangement is shown as an example (FIG. 15). Any of existing color CCD arrangements such as a primary-colors CCD of the Bayer arrangement (not shown) can be applicable.

With the arrangement above, it is possible to precisely detect the light environment in which the image display device is placed. Moreover, the color of another light source becomes detectable when light from another light source comes in via a roundabout way.

Thus, a natural image can be displayed by adding information about the position, intensity and color of the light source to data on a three-dimensional image to be displayed.

A mode for carrying out the invention has been described by reference to the embodiments. However, the invention is not limited to those embodiments thereof but may be modified in various ways.

A three-dimensional image display device for displaying a natural three-dimensional image can be provided by measuring the light source conditions in the real space and reflecting in each image the light source conditions measured by the image display device.

Therefore, the light source conditions in the display position of the three-dimensional image can be reflected in the lightness of the three-dimensional image, the positions of reflections and shadows, so that a more natural three-dimensional image is displayable.

What is claime is:

1. A three-dimensional image display method comprising
detecting a position of a light source
comparing the position of the light source and a virtual position of a display object in a three-dimensional image to obtain a relative positional relation therebetween; and
shading in the three-dimensional image.

2. The method according to claim 1, further comprising detecting lightness of the light source.

3. A three-dimensional image display method comprising
detecting positions of a plurality of light sources
comparing each of the positions of the light sources and a virtual position of a display object in a three-dimensional image to obtain relative positional relations therebetween; and
shading in the three-dimensional image.

4. The method according to claim 1, further comprising obtaining a position of a single virtual light source, which represents the plurality of light sources,
wherein in the comparing step, the position of light source and the virtual position of the display object in the three-dimensional image to obtain the relative positional relations therebetween.

5. A three-dimensional image display device comprising:
a detector which detects a position of a light source
an image process unit configured to compare the position of the light source and a virtual position of a display object in a three-dimensional image to obtain a relative positional relation therebetween, and to shade in the three-dimensional image.

6. A three-dimensional image display device comprising:
a plurality of detectors which detects a position of a light source
an image process unit configured to compare the position of the light source and a virtual position of a display object in a three-dimensional image to obtain a relative positional relation therebetween, and to shade in the three-dimensional image.

7. The device according to claim 5, further comprising:
a display surface configure to display the three-dimensional image, wherein:
the detector is disposed on at least one of the display surface and a surface adjacent to the display surface.

8. The device according to claim 5, further comprising:
a display surface configure to display the three-dimensional image, wherein:
the detector is disposed to be adjacent to the display surface.

9. The device according to claim 5, wherein the detector is disposed at a position where the detector which detects the light source from the light in the same direction as at least one of a display direction of the three dimensional image and a direction in which the three-dimensional image is observed.

10. The device according to claim 5, wherein:
the detector includes three-primary-colors detection means for adding colors to the shade

11. A light direction detection device comprising:
a light detection array disposed on a substrate; and
a discontinuous light shielding member standing perpendicularly to the substrate.

12. The device according to claim 11, wherein the light shielding member has a bar shape.

13. The device according to claim 11, wherein:
the light shielding member includes a plurality of portions; and
one of the portions is different from another of the portions in thickness.

14. The device according to claim 11, wherein:
the light shielding member includes a plurality of portions; and
one of the portions is made of a different medium from that of another of the portions.

15 The device according to claim 11, wherein an incident direction of incident light and an incident angle of the incident light are detected on the basis of number of shadows of the light shielding member from the root of the light shielding member and a position of a front end portion of the shadows.
